(19) United States
(12) Patent Application Publication
(10) Pub. No.: US 2021/0183240 A1
(43) Pub. Date: Jun. 17, 2021

(54) SMART INTERSECTION WITH CRITICALITY DETERMINATION

(71) Applicant: Continental Automotive Systems, Inc., Auburn Hills, MI (US)

(72) Inventor: Vivian Swan, Auburn Hills, MI (US)

(21) Appl. No.: 16/710,553

(22) Filed: Dec. 11, 2019

(51) Int. Cl. G08G 1/01; G06N 20/00; G08G 1/0968

(52) U.S. Cl. CPC G08G 1/0145; G08G 1/096888; G08G 1/0112; G06N 20/00

(57) ABSTRACT

A method of communicating with traffic participants according to an example of this disclosure includes storing data of traffic participant tendencies at an intersection. The method further includes sensing real-time movement characteristics of all traffic participants in the proximity of the intersection. The method further includes determining that it is impracticable to communicate all movement data with all traffic participants in the proximity of the intersection and then calculating a criticality level of one or more traffic participants in the proximity of the intersection based on their movement characteristics and the traffic participant tendencies at the intersection. The method further includes developing a limited communication strategy for the one or more traffic participants based on their criticality level; and then communicating accident prevention information to one or more of the traffic participants according to the limited communication strategy through a communication means.

### BACKGROUND

In an ideal world, traffic participants would always follow the law. However, in the real world, and especially in urban environments, frequently pedestrians jaywalk and vehicles run red lights. This can increase their likelihood of being involved in a collision.

The advent of smart vehicles and smart phones has made it possible to digitize communication with traffic participants and further attempt to avoid these accidents. Predictive movement data and accident prevention warnings can be communicated to a smart vehicle's processor or to a pedestrian's smartphone. However, traffic congestion and bandwidth issues may make it impracticable to communicate on behalf of or with each traffic participant individually. In such cases, it is desirable to determine the criticality of each traffic participant and prioritize communication based on those who are most at risk.

### SUMMARY

A method of communicating with traffic participants according to an example of this disclosure includes storing data of traffic participant tendencies at an intersection. The method further includes sensing real-time movement characteristics of all traffic participants in the proximity of the intersection. The method further includes determining that it is impracticable to communicate all movement data with all traffic participants in the proximity of the intersection and then calculating a criticality level of one or more traffic participants in the proximity of the intersection based on their movement characteristics and the traffic participant tendencies at the intersection. The method further includes developing a limited communication strategy for the one or more traffic participants based on their criticality level; and then communicating accident prevention information to one or more of the traffic participants according to the limited communication strategy through a communication means.

In a further example of the foregoing, the limited communication strategy includes communicating accident prevention information for traffic participants with higher criticality to all traffic participants in the proximity of the intersection.

In a further example of any of the foregoing, the limited communication strategy includes only communicating accident prevention information for a traffic participant if their criticality level is above a predetermined level.

In a further example of any of the foregoing, the limited communication strategy includes communicating accident prevention information for as many traffic participants as possible up to a bandwidth limit of the communication means, prioritizing traffic participants with a higher criticality.

In a further example of any of the foregoing, the limited communication strategy includes only communicating accident prevention information to traffic participants with a higher criticality level.

In a further example of any of the foregoing, it is impracticable to communicate all movement data with all traffic participants if either there are more traffic participants than a predetermined limit in the proximity of the intersection or if communicating all movement data to all traffic participants would exceed a bandwidth limit of the communication means.

In a further example of any of the foregoing, wherein the movement characteristics of the one or more traffic participants includes their speed, acceleration, location, and relative movement direction.

In a further example of any of the foregoing, the method further includes grouping traffic participant movement outcomes with their movement characteristics as they approach the intersection in conjunction with current traffic signals of the intersection and the time of day to determine traffic participant tendencies at the intersection, prior to the storing data step.

In a further example of any of the foregoing, traffic participant tendencies includes the tendencies of traffic participants to ignore traffic signals.

In a further example of any of the foregoing, traffic participant tendencies includes the tendencies of pedestrians to jaywalk at certain hours of the day.

In a further example of any of the foregoing, traffic participant tendencies include the tendencies of vehicles to cross through an intersection with a given traffic light phase signal at certain hours of the day.

In a further example of any of the foregoing, the one or more traffic participants includes all traffic participants in the proximity of an intersection.

In a further example of any of the foregoing, the accident prevention information is at least one of real-time movement characteristics of traffic participants, predicted movement outcomes of traffic participants, details of potential accidents, and warning messages.

A system according to an example of this disclosure includes one or more sensors detecting the movement characteristics of one or more traffic participants in the proximity of an intersection. The sensors communicate data to a control. A communication means is also in communication with the control. The control stores data of movement outcome tendencies for traffic participants at the intersection and predicts probabilistic movement outcomes for each of the one or more traffic participants by a comparison to the data of movement outcome tendencies. Further, the control calculates a criticality level for each of the one or more traffic participants by comparing their probabilistic movement outcomes with one another and instructs the communication means to communicate accident prevention information to the one or more traffic participants based on the criticality level of the one or more traffic participants.

In a further example of the foregoing, the control learns movement outcome tendencies by grouping traffic participant movement outcomes with their movement characteristics as they approach the intersection in conjunction with current traffic signals of the intersection and the time of day.

In a further example of any of the foregoing, the control incorporates a machine-learning component to learn movement outcome tendencies.

In a further example of any of the foregoing, movement characteristics includes traffic participant's speed, acceleration, location, and relative movement direction, and movement outcome tendencies include the probability that a traffic participant will ignore a traffic signal at the intersection.

In a further example of any of the foregoing, the accident prevention information is at least one of real-time movement characteristics of traffic participants, predicted movement outcomes of traffic participants, details of potential accidents, and warning messages.

In a further example of any of the foregoing, the communication means comprises a data transceiver broadcasting to a traffic participants cell phone or to a smart vehicle processor.

In a further example of any of the foregoing, the communication means comprises at least one of a visual display and an audible speaker system.

### BRIEF DESCRIPTION OF THE DRAWINGS

FIG. 1 illustrates an intersection with a smart infrastructure component incorporating criticality factoring.

FIG. 2 illustrates a criticality-factoring algorithm of a smart infrastructure component.

FIG. 3 illustrates a method of communicating with traffic participants incorporating criticality factoring.

### DETAILED DESCRIPTION

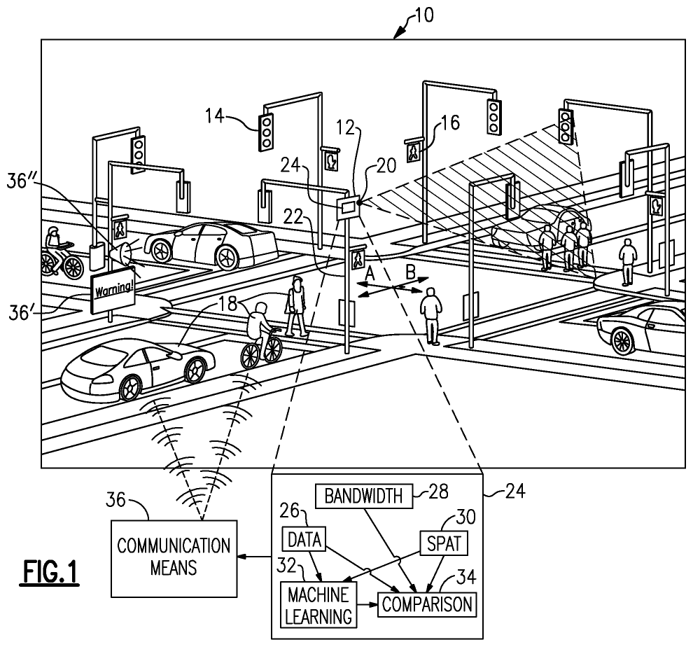

FIG. 1 illustrates an intersection 10 incorporating a smart infrastructure component 12. FIG. 1 illustrates a typical four-way vehicle intersection wherein two perpendicular roads intersect and the ingress and egress of vehicles through the intersection is regulated by phased traffic lights 14 (green, yellow, red). The illustrated intersection further includes crosswalks and crosswalk signals 16 (walk, don't walk), which regulate the movement of sidewalk pedestrians. Throughout this application, the term “traffic participant” 18 includes vehicles, pedestrians, and bicyclists.

At a well-programmed traffic intersection, such as intersection 10, while a traffic phase 14 or signal 16 instructs traffic participants 18 to proceed in a first direction A, traffic participants moving in a second perpendicular direction B are instructed to stop. If all traffic participants follow these signals then “T-bone” and pedestrian crossing collisions at intersections will be avoided. However, frequently pedestrians jaywalk and vehicles run red lights. Accordingly, smart infrastructure component 12 determines the probability of traffic participants 18 ignoring traffic laws and communicates warnings for traffic participants 18 presented with a collision risk created by that conduct.

Smart infrastructure component 12 includes sensors 20 capable of obtaining the real-time movement characteristics of all traffic participants in the proximity of intersection. The movement characteristics of a traffic participant include their speed, acceleration, location, and relative movement direction. In one embodiment, the relevant proximity of the intersection is defined as within a fifty foot radius of the intersection. In other embodiments, it is defined as far out as within a one-hundred or two-hundred foot radius of the intersection depending on the field of view of the sensors. The sensors 20 are also capable of detecting and identifying the occurrence of an adverse traffic event, such as a collision. The sensors 20 may consist of radars, LiDARs, ultrasonic, vision based sensors, or any other appropriate sensor.

The smart infrastructure component 12 is preferably attached to a static structure 22 of the intersection 10. For example, smart infrastructure component may be mounted on a structure supporting traffic lights 14 or crosswalk signals 16, as illustrated in FIG. 1. Alternatively, smart infrastructure component 12 may be mounted on a stand-alone structure.

The smart infrastructure component further includes a controller 24. Controller 24 includes a data module 26 in communication with a bandwidth detection module 28, a signal, phase and timing (or “SPAT”) module 30, a machine-learning module 32, and a comparison module 34. The data module 26 is in communication with the sensors 20 to access data or information relating to the real-time movement characteristics of traffic participants 18 in proximity of the intersection 10. The bandwidth detection module 28 determines if it is practicable to communicate all traffic data to all traffic participant 18 in the proximity of the intersection 10. The SPAT module 30 determines the current phase (green, yellow, red) of traffic lights 14, the signal (walk, don't walk) of the pedestrian crossing signal 16, as well as the time of day. The machine-learning module 32 learns the tendencies of traffic participants 18 at the intersection 10. The comparison module 34 compares the real-time movement characteristics of traffic participants 18 (communicated by the data module 26) to corresponding tendencies (communicated by the machine-learning module 32) to predict future movement of traffic participants 18 and determine their criticality. As illustrated in FIG. 1, the control 24 may be positioned locally as part of smart infrastructure component 12 and be specific to intersection 10. In another embodiment, control 24 may be located remotely at a centralized hub communicating and controlling multiple smart infrastructure components at multiple intersections.

The smart infrastructure component further includes a communication means 36 instructed by the controller 24 to communicate specified information with traffic participants 18 when appropriate. Communication means 36 is preferably a data transmitter and broadcasts to either a pedestrian's phone or a smart vehicles processor through one of Wi-Fi, Bluetooth, cellular, DSRC, or any other appropriate data communication method. Alternatively, communication means 36 may communicate with traffic participants through a visual display 36′ or an audible speaker system 36″ located at intersection 10.

In one embodiment, communication means 36 communicates accident prevention information in the form of at least one of real-time movement characteristics, predictive movement outcomes, and potential accidents to the processor of smart vehicles in the proximity of the intersection. Smart vehicles with autonomous capabilities may be able to use this data to avoid accidents without driver intervention. For example, a smart vehicle may slow down, stop, or perform an evasive maneuver to avoid a collision course predicted by the smart infrastructure component 12 or by on-board computation of the vehicles processor. In other embodiments, the communication means 36 simply provides a warning to the traffic participant 18 predicted to be involved in an adverse traffic event with or without details.

In one example, the smart infrastructure component 12 first operates in a learning mode prior to any communications with traffic participants 18. In this mode, the machine-learning module 32 determines a traffic pattern or tendency of traffic participants 18 at the intersection 10 by grouping traffic participant 18 movement outcomes with movement data obtained from the data module 26 and information provided by the SPAT module 30 over a period of time. In other words, the machine-learning module 32 learns the probability that a traffic participant 18 will continue through the intersection 10 (movement outcome) given their speed, acceleration, location, and relative direction as they approach the intersection (data module 26), in conjunction with the current traffic light phase 14, crosswalk signal 16, and time of day (SPAT module 30).

For example, the machine-learning module 32 may learn that a pedestrian approaching intersection 10 at a jog in direction A is likely to ignore the crosswalk “don't walk” signal 16 from the hours of 11 a.m. to noon, but is likely to obey from 5 p.m. to 6 p.m. As another example, the machine-learning module 32 may learn that a vehicle heading in direction B and accelerating towards a red light during rush hour is likely to ignore the traffic light 14 and continue through the intersection 10.

Machine-learning module 32 may comprise a neural network or any other appropriate known machine-learning algorithm. Preferably, the machine-learning module 32 learns under an unsupervised learning technique as described above; making groupings out of the information provided by the data module 26 and SPAT module 30. However, the machine-learning module 32 may also learn under a supervised learning technique wherein movement outcome probabilities are manually observed and fed into the machine-learning module 32 as data sets.

When the machine-learning module 32 is capable of predicting the movement outcomes of traffic participants 18 to an acceptable degree of accuracy, then smart infrastructure component 12 may be set to operate in a warning mode. In this mode, the comparison module compares real-time movement data of all traffic participants 18 in the proximity of the intersection (communicated by the data module 26) with the predicted tendencies of individual traffic participants 18 (communicated by the machine-learning module 32). In this manner, the comparison module 34 analyzes the current location and probabilistic movement of all traffic participants 18 in the proximity of an intersection 10 and determines the likelihood of any number of those traffic participants 18 colliding with one another. For example, if a vehicle is approaching a green light in direction A, a pedestrian is approaching the intersection in direction B, and the machine-learning module 32 indicates that previously pedestrians with similar movement characteristics have frequently jaywalked at the present time of day, then the comparison module 34 will determine there is a risk of collision.

In a preferred embodiment, the machine-learning module 32 continues to refine the accuracy of its movement outcome predictions while operating in the warning mode. As the smart infrastructure component 12 operates and receives more and more traffic participant data, the machine-learning module 32 can continue to pair movement outcomes with information from the data module 26 and SPAT module 30, and continuously improve the accuracy of predictions.

Ideally, when any risk is present, the controller 24 would instruct communication means 36 to relay all traffic information to all relevant traffic participants 18 in the proximity of intersection 10. However, in many cases the risk of collision for a certain traffic participant 18 is miniscule. Moreover, there are situations in which the bandwidth detection module 28 may determine that communicating or broadcasting all traffic data to all traffic participants 18 is impracticable, such as if there are more traffic participants 18 in the proximity of the intersection than a predetermined limit or if communications to all traffic participants 18 would exceed a bandwidth limit of the communication means 36. Accordingly, in such situations, the comparison module 34 performs a criticality determination for all traffic participants and determines a limited communication strategy based on the criticality levels.

In one embodiment, the limited communication strategy includes communicating the movement data or a warning message on behalf of traffic participants 18 with higher criticality levels to all traffic participants 18 in the proximity of the intersection 10, and not communicating on behalf of traffic participants 18 with lower criticality levels. In other words, under this limited communication strategy, the communication means 36 means delivers a reduced list of more relevant data to accident avoidance to all traffic participants 18 when bandwidth limitations make it impossible or impractical to communicate or broadcast on behalf of all traffic participants.

In another embodiment, the limited communication strategy includes only communicating the movement data of other traffic participants 18 or a warning message to a subset of traffic participants 18 with higher criticality levels. In this manner, the communication means 36 provides a complete list of data to a reduced number of traffic participants 18 in the proximity of the intersection 10.

Moreover, the limited communication strategy may fall somewhere in between the two foregoing strategies. The communication means 36 may communicate a reduced list of the most relevant traffic data to only a subset of traffic participants 18 based on the criticality determination.

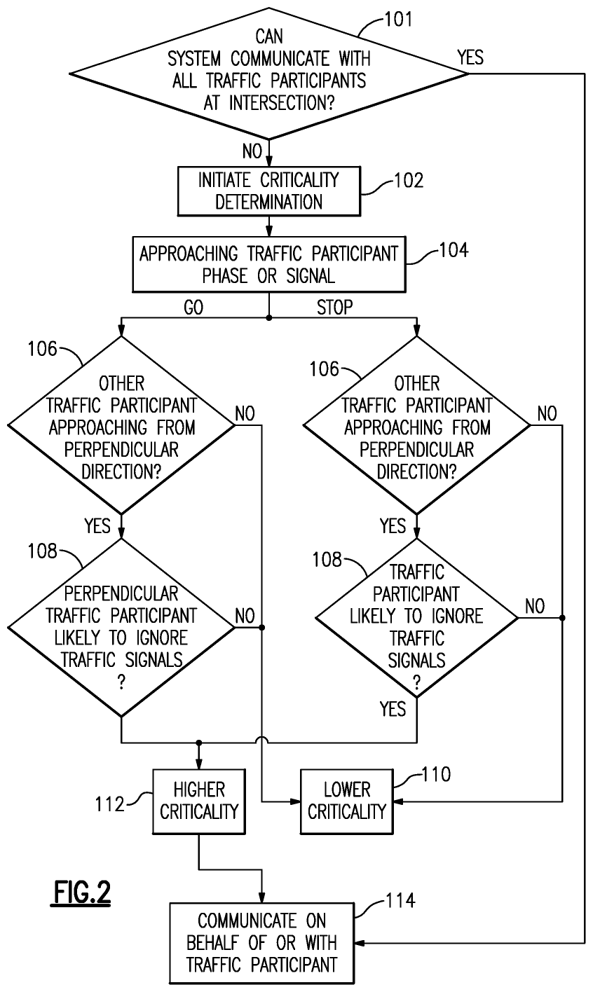

FIG. 2 illustrates a simplified algorithm 100 performed by the controller 24 while operating in the warning mode. At step 101 the bandwidth detection module 28 of the controller 24 determines if it is practicable to communicate all traffic data with all traffic participants 18 in the proximity of intersection 10. If it is, then the controller 24 will instruct the communication means 36 to communicate with each traffic participant 18 (or simply broadcast) at step 114. If not, then the criticality determination for each individual traffic participant 18 is initiated at step 102.

At step 104 the data module 26 and SPAT module 30 work in conjunction to determine if a particular traffic participant 18 is approaching a phase or signal 14, 16 instructing them to go or stop. At step 106 the data module 26 determines if there is a traffic participant 18 approaching from a perpendicular direction with movement characteristics indicating a potential collision. At step 108 the comparison module 34 compares the movement characteristics of the traffic participant 18 from the data module 26 to the traffic tendencies learned by the machine-learning module 32 and determines the probability that either the subject traffic participant 18 or a perpendicular traffic participant 18 will ignore a traffic stop 14, 16. If there is simply no perpendicular traffic participant 18 at the intersection or no traffic participants 18 are likely to ignore a traffic stop 14, 16, then the criticality of the subject traffic participant 18 is determined to be lower at step 110. Conversely, if there is another traffic participant 18 on a collision course with the subject traffic participant 18, and either traffic participant is likely to ignore a traffic stop 14, 16, then the criticality of the subject traffic participant is determined to be higher at step 112. If the traffic participants has a higher criticality, at step 114 the controller prioritizes communicating on behalf of or with that traffic participant 18 through communication means 36.

It should be understood, that algorithm 100 is a simplified algorithm intended to be illustrative. The criticality determination does not involve binary choices, but rather involves an evaluation of combined probabilities. The various movement characteristics and SPAT factors each serve to increase or decrease the probability that individual traffic participants will continue through a traffic stop 14,16, creating a spectrum of risk or criticality. The controller 24 may instruct the communication means to only communicate on behalf of or with a traffic participant 18 when a certain criticality level is reached, or it may communicate on behalf of or with as many traffic participants 18 as possible, prioritizing those with a higher criticality level.

Further, a criticality determination similar to algorithm 100 is performed for each traffic participant in the proximity of the intersection 10 continuously. A criticality calculation may be performed multiple times on a single traffic participant 18 at multiple stages as they approach and move through intersection 10.

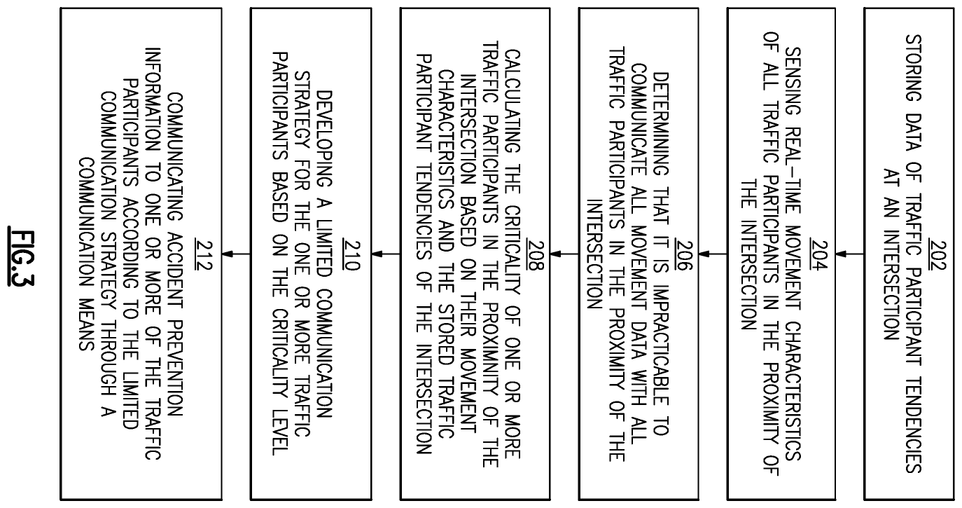

FIG. 3 illustrates a method 200 of collision prevention according to the present invention. Step 202 includes storing data of traffic participant 18 tendencies at an intersection 10. Step 204 includes sensing real-time movement characteristics of all traffic participants in the proximity of the intersection. Step 206 includes determining that it is impracticable to communicate all movement data with all present traffic participants 18 in the proximity of the intersection 10. Step 208 includes calculating the criticality of one or more traffic participants 18 in the proximity of the intersection 10 based on their movement characteristics and the stored traffic participant 18 tendencies of the intersection. Step 210 includes developing a limited communication strategy for the one or more traffic participants 18 based on their criticality level. Finally, step 210 includes communicating accident prevention information to one or more of the traffic participants 18 according to the limited communication strategy through a communication means 36.

It should be recognized that the preceding description is exemplary rather than limiting in nature. The invention can be practiced other than exactly as described. While a typical four-way, traffic-light vehicle intersection 10 has been illustrated in FIG. 1, and an associated algorithm 100 provided, it should be understood that the invention could be applied to other types of intersections, such as intersections with stop signs, intersections without pedestrian crossings, roundabouts, highway interchanges, T-intersections, or any other type of intersection. A worker would recognized that certain modifications and variations in light of the above teachings will fall within the scope of the appended claims. Accordingly, the claims should be studied to determine the true scope and content of the legal protection given to this disclosure.

What is claimed is:

1. A method of communicating with traffic participants comprising:
storing data of traffic participant tendencies at an intersection;
sensing real-time movement characteristics of all traffic participants in the proximity of the intersection;
determining that it is impracticable to communicate all movement data with all traffic participants in the proximity of the intersection;
calculating a criticality level of one or more traffic participants in the proximity of the intersection based on their movement characteristics and the traffic participant tendencies at the intersection;
developing a limited communication strategy for the one or more traffic participants based on their criticality level; and
communicating accident prevention information to one or more of the traffic participants according to the limited communication strategy through a communication means.

2. The method of claim 1, wherein the limited communication strategy includes communicating accident prevention information for traffic participants with higher criticality to all traffic participants in the proximity of the intersection.

3. The method of claim 2, wherein the limited communication strategy includes only communicating accident prevention information for a traffic participant if their criticality level is above a predetermined level.

4. The method of claim 2, wherein the limited communication strategy includes communicating accident prevention information for as many traffic participants as possible up to a bandwidth limit of the communication means, prioritizing traffic participants with a higher criticality.

5. The method of claim 1, wherein the limited communication strategy includes only communicating accident prevention information to traffic participants with a higher criticality level.

6. The method of claim 1, wherein it is impracticable to communicate all movement data with all traffic participants if either there are more traffic participants than a predetermined limit in the proximity of the intersection or if communicating all movement data to all traffic participants would exceed a bandwidth limit of the communication means.

7. The method of claim 1, wherein the movement characteristics of the one or more traffic participants includes their speed, acceleration, location, and relative movement direction.

8. The method of claim 7, further including grouping traffic participant movement outcomes with their movement characteristics as they approach the intersection in conjunction with current traffic signals of the intersection and the time of day to determine traffic participant tendencies at the intersection, prior to the storing data step.

9. The method of claim 1, wherein traffic participant tendencies includes the tendencies of traffic participants to ignore traffic signals.

10. The method of claim 9, wherein traffic participant tendencies includes the tendencies of pedestrians to jaywalk at certain hours of the day.

11. The method of claim 9, wherein traffic participant tendencies include the tendencies of vehicles to cross through an intersection with a given traffic light phase signal at certain hours of the day.

12. The method of claim 1, wherein the one or more traffic participants includes all traffic participants in the proximity of an intersection.

13. The method of claim 1, wherein the accident prevention information is at least one of real-time movement characteristics of traffic participants, predicted movement outcomes of traffic participants, details of potential accidents, and warning messages.

14. A system comprising:
one or more sensors detecting the movement characteristics of one or more traffic participants in the proximity of an intersection, the sensors communicating data to a control;
a communication means in communication with the control;
wherein the control stores data of movement outcome tendencies for traffic participants at the intersection;
wherein the control predicts probabilistic movement outcomes for each of the one or more traffic participants by a comparison to the data of movement outcome tendencies;
wherein the control calculates a criticality level for each of the one or more traffic participants by comparing their probabilistic movement outcomes with one another;
wherein the control instructs the communication means to communicate accident prevention information to the one or more traffic participants based on the criticality level of the one or more traffic participants.

15. The system of claim 14, wherein the control learns movement outcome tendencies by grouping traffic participant movement outcomes with their movement characteristics as they approach the intersection in conjunction with current traffic signals of the intersection and the time of day.

16. The system of claim 15, wherein control incorporates a machine-learning component to learn movement outcome tendencies.

17. The system of claim 15, wherein movement characteristics include traffic participant's speed, acceleration, location, and relative movement direction, and movement outcome tendencies include the probability that a traffic participant will ignore a traffic signal at the intersection.

18. The system of claim 14, wherein the accident prevention information is at least one of real-time movement characteristics of traffic participants, predicted movement outcomes of traffic participants, details of potential accidents, and warning messages.

19. The system of claim 18, wherein the communication means comprises a data transceiver broadcasting to a traffic participants cell phone or to a smart vehicle processor.

20. The system of claim 18, wherein the communication means comprises at least one of a visual display and an audible speaker system.
